(19) United States
(12) Patent Application Publication
(10) Pub. No.: US 2009/0106447 A1
(43) Pub. Date: Apr. 23, 2009

(54) Method And System For Transitioning Between Content In Web Pages

(76) Inventor: David B. Lection, Raleigh, NC (US)

Correspondence Address: SCENERA RESEARCH, LLC, 111 CORNING RD., SUITE 220, CARY, NC, 27518, US

(21) Appl. No.: 11/876,961

(22) Filed: Oct. 23, 2007

(51) Int. Cl. G06F 15/16

(52) U.S. Cl. 709/236

(57) ABSTRACT

Methods and systems are described for presenting a transition between content in web pages. One method includes receiving content associated with a first web page that includes a presentable representation of the first web page, and a request for a second web page, rendering the second webpage to retrieve content associated with the second web page including a presentable representation of the second web page, and generating a transition video object stream including a first frame including content related to the content associated with the first web page, an intermediate frame that does not include the content associated with the first and second web pages, and a final frame including content related to the content associated with the second web page. The transition video object stream is sent to a browser for presentation in conjunction with the first and second web pages.

### BACKGROUND

As the World Wide Web evolves from two dimensional static web pages to dynamic and interactive videos and three dimensional virtual communities, the manner in which web browsers retrieve and present web oriented content is surprisingly primitive. For example, when a user is viewing a web page presented on a device and submits a request for another web page, the user is typically subjected to page transitions in the form of interstitial popup windows, or popover windows within the current page. These are disruptive, annoying and visually not appealing.

In addition, depending on the presenting device's network connection, the amount of time required to download the content can be significant. During this waiting time, the user is typically presented with a partially loaded web page or a spinning icon and some indication that the page is loading. In the meantime, the user can become bored and impatient, and may eventually lose interest in the page altogether.

Accordingly, there exists a need for methods, systems, and computer program products for presenting a transition between content in a first web page and content in a second web page. The transition should be visually appealing and entertaining such that the user's attention is captured during a time period in which the content from the second web page is loading.

### SUMMARY

Methods and systems are described for providing a transition between content in web pages. One method includes receiving content associated with a first web page that includes a presentable representation of the first web page, and a request for a second web page, rendering the second webpage to retrieve content associated with the second web page including a presentable representation of the second web page, and generating a transition video object stream including a first frame including content related to the content associated with the first web page, an intermediate frame that does not include the content associated with the first and second web pages, and a final frame including content related to the content associated with the second web page. The transition video object stream is sent to a browser for presentation in conjunction with the first and second web pages.

In another aspect of the subject matter disclosed herein, a system for providing a transition between content in web pages includes a content handler component configured for receiving content associated with a first web page that includes a presentable representation of the first web page, and a request for a second web page, a page retriever component configured for rendering the second webpage to retrieve content associated with the second web page including a presentable representation of the second web page, and a transition video rendering processor configured for generating a transition video object stream including a first frame including content related to the content associated with the first web page, an intermediate frame that does not include the content associated with the first and second web pages, and a final frame including content related to the content associated with the second web page. The system also includes a video streamer component configured for sending the transition video object stream to a browser for presentation.

In another aspect of the subject matter disclosed herein, another system for providing a transition between content in web pages means for receiving content associated with a first web page that includes a presentable representation of the first web page, and a request for a second web page, means for rendering the second webpage to retrieve content associated with the second web page including a presentable representation of the second web page, means for generating a transition video object stream including a first frame including content related to the content associated with the first web page, an intermediate frame that does not include the content associated with the first and second web pages, and a final frame including content related to the content associated with the second web page, and means for sending the transition video object stream to a browser for presentation in conjunction with the first and second web pages.

In another aspect of the subject matter disclosed herein, a computer readable medium containing a computer program, executable by a machine, for providing a transition between content in web pages is disclosed. The computer program comprises executable instructions for receiving content associated with a first web page that includes a presentable representation of the first web page, and a request for a second web page, for rendering the second webpage to retrieve content associated with the second web page including a presentable representation of the second web page, for generating a transition video object stream including a first frame including content related to the content associated with the first web page, an intermediate frame that does not include the content associated with the first and second web pages, and a final frame including content related to the content associated with the second web page, and for sending the transition video object stream to a browser for presentation in conjunction with the first and second web pages

In another aspect of the subject matter disclosed herein, a method for presenting transitional information while a web page is being rendered includes receiving a request for a second web page while a first web page is presented and transmitting content associated with the first web page that includes a presentable representation of the first web page, and the request for the second webpage to a transition service. The method also includes generating and presenting a pre-transition video segment including the content associated with the first web page, receiving from the transition service a transition video object stream including a first frame including content related to the content associated with the first web page, an intermediate frame that does not include the content associated with the first and second web pages, and a final frame including content related to the content associated with the second web page, and presenting the transition video object stream in conjunction with the first and second web pages.

### BRIEF DESCRIPTION OF THE DRAWINGS

Objects and advantages of the present invention will become apparent to those skilled in the art upon reading this description in conjunction with the accompanying drawings, in which like reference numerals have been used to designate like elements, and in which:

FIG. 1 is a block diagram illustrating an exemplary system for providing a transition between content in web pages according to an exemplary embodiment;

FIG. 2 is a block diagram illustrating an exemplary transition device according to an exemplary embodiment;

FIG. 3 is a flowchart illustrating a method of providing a transition between content in web pages according to one exemplary embodiment;

FIG. 4 is a block diagram illustrating an exemplary client device according to an exemplary embodiment;

FIG. 5 is a flowchart illustrating an exemplary method of presenting transitional information while a web page is being rendered according to an exemplary embodiment; and

FIG. 6 is a block diagram illustrating another exemplary system for providing a transition between content in web pages according to an exemplary embodiment.

### DETAILED DESCRIPTION

Methods, systems, and computer program products for providing a transition between content in web pages are disclosed. According to one embodiment, a transition between content of a current (first) web page and content of a second web page comprises a transition video object stream that includes smooth motion video content and optionally audio content. The video content provides a smooth motion transition between the content of the current web page and the content of the second web page.

In one embodiment, the transition video object stream includes a first segment that includes content of the first web page, a second segment that does not include content of either the first or second web page, and a third segment that includes content of the second web page. The transition video object stream is presented in a continuous uninterrupted sequence on a client browser while the content of the second web page is loading. In one embodiment, the duration of any segment of the transition video object stream can be adjusted to ensure a continuous and smooth transition, thereby providing a smooth and entertaining browsing experience for the user.

Because rendering the transition video object stream for presentation to the user can require a relatively high amount of computer power, the rendering task can be distributed, in one embodiment, to a transition service in a secondary processing unit independent from the primary processing unit of the client device. The secondary processing unit can be located on a remote device, e.g., a server, or can be co-existing, e.g., a co-processor, within the client device. In either case, the rendering task can be offloaded from the primary processing unit such that a smooth delivery of the transition video object stream can be implemented.

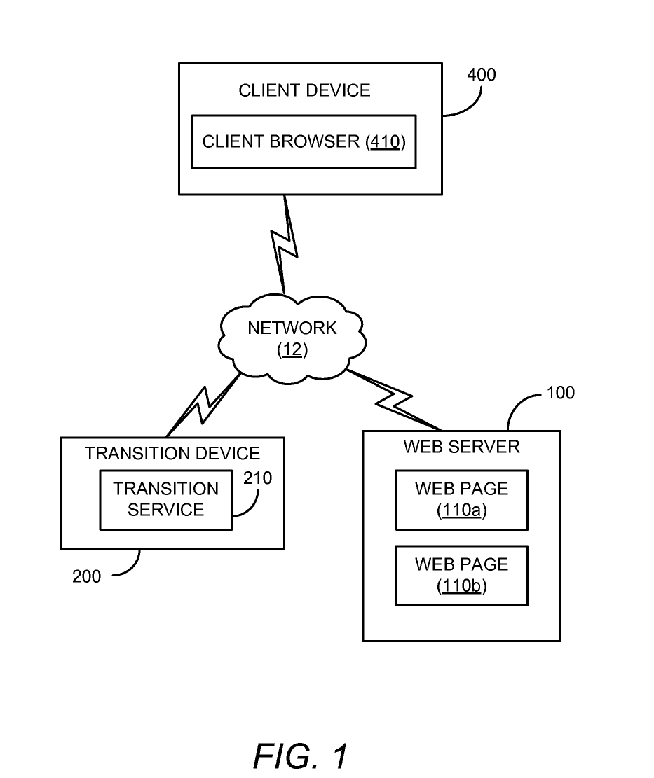

FIG. 1 is a block diagram illustrating an exemplary system according to one embodiment. FIG. 1 illustrates a client device 400 communicatively coupled to a web server 100 by a network 12. The network 12 may be a Local Area Network (LAN) and/or a Wide Area Network (WAN) including the Internet. In one embodiment, the client device 400 includes a client browser component 410 for requesting, receiving and presenting web content from the web server 100. The client device 400 provides an operating environment that supports the operation of the client browser 410 and other components. For example, the client device 400 can include a processor, an operating system or control program, a network subsystem, input/output subsystems, and memory subsystems. The web server 100 stores and manages web content in a plurality of web pages 110a, 110b and is configured to receive requests for web content, to retrieve the requested web content, and to send the requested web content to the requesting client device 400 via the network 12.

According to an exemplary embodiment, the client device 400 is also communicatively coupled to a transition device 200 by the network 12. The transition device 200 can by any device, e.g., a server, a laptop computer, a handheld phone, or a PDA, capable of sending and receiving messages over the network 110, and includes, in an exemplary embodiment, a transition service 210 that provides a transition video object stream which smoothly bridges content of a first web page, e.g., 110a, and content of a second web page, e.g., 110b. Like the client device 400, the transition device 200 provides an operating environment that supports the operation of the transition service 210. For example, the transition device 200 can include a processor, an operating system or control program, a network subsystem, input/output subsystems, and memory subsystems.

In one embodiment, the client browser 410 in the client device 400 is configured to receive and present content of the first web page 110a in a display (not shown) of the client device 400. While the first web page 110a is presented, the user can request to receive content of the second web page 110b. The browser 410, in one embodiment, is configured to send the request to the transition service 210, instead of directly to the web server 100. Upon receiving the request, the transition service 210 is configured, in an exemplary embodiment, to generate the transition video object stream and to retrieve the content of the second web page simultaneously.

As the transition video object stream is being generated, the transition service 210 can stream the generated portions of the transition video object stream to the browser 410 in the client device 400 for presentation to the user while the transition service 210 is receiving and rendering the content of the second web page 110b. In one embodiment, a portion of the transition video object stream can be tailored to the user's preferences. While in another embodiment, portions of the transition video object stream can be based on the content or subject matter of the first and/or second web pages 110a, 110b.

Accordingly, while the content of the second web page 110b is being processed, the user can enjoy watching the transition video object stream instead of an empty or partially formed window. In an exemplary embodiment, when the transition service 210 has received and rendered the entire content of the second web page 110b, the content of the second web page 110b can be sent to the browser 410 for presentation to the user after the presentation of the transition video object stream.

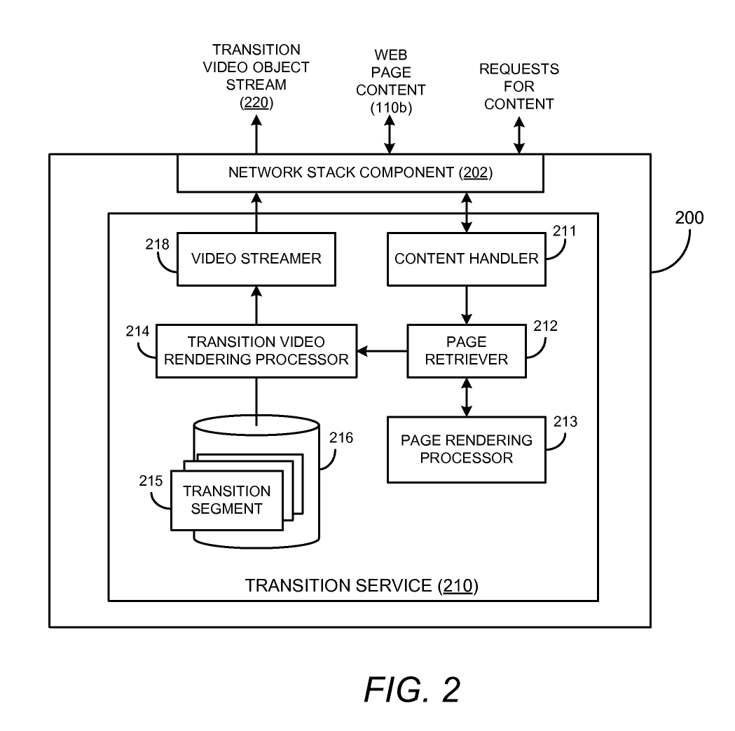

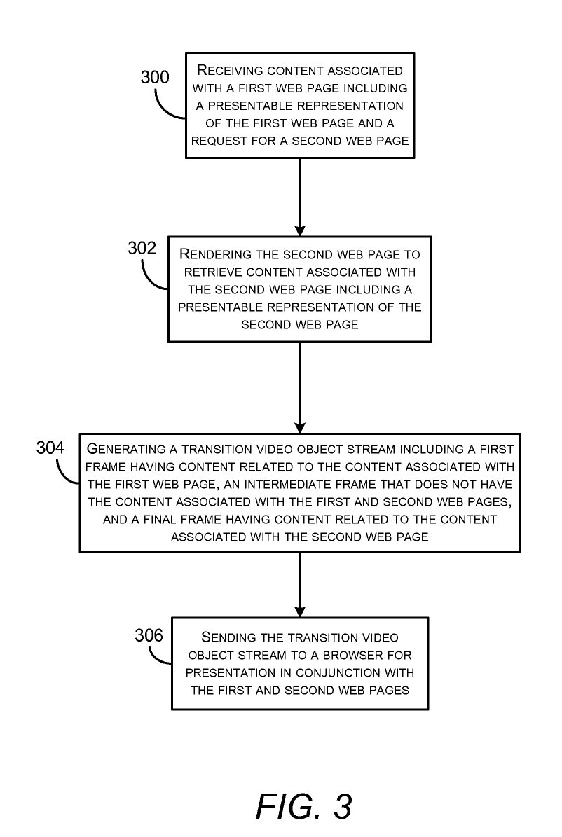

To describe more fully the functionality of the transition service 210, reference to FIG. 2 and FIG. 3 is made. FIG. 2 is a block diagram illustrating a transition device 200 according to one embodiment, and FIG. 3 is a flowchart illustrating an exemplary method for providing a transition between content in web pages from a perspective of the transition service 210 according to one embodiment. Referring to FIGS. 2 and 3, the process begins when the transition service 210 receives content associated with a first web page that includes a presentable representation of the first web page, and a request for a second web page (block 300). In an exemplary embodiment, the transition service 210 includes means for receiving the content and the request. For example, a content handler component 211 in the transition service 210 can be configured for receiving content associated with a first web page that includes a presentable representation of the first web page, and a request for a second web page.

In one embodiment, the content handler component 211 can be figured to receive and send HTTP messages to and from the client device 400 via a network stack component 202. The network stack component 202 is communicatively coupled to the network 12 via a wired or wireless connection. The network 12 can be a TCP/IP network or other network. In one embodiment, HTTP request headers received by the content handler component 211 via the network stack component 202 are analyzed, decoded and separated to extract content contained in the headers. Content included in HTTP request headers can include a session identifier, a URL identifying a page to be retrieved and other MIME encoded content to be processed by the service 210.

According to an exemplary embodiment, the HTTP request headers include the presentable representation of the first web page 110a and the request for the second web page 110b, which includes the URL of the second web page 110b. In one embodiment, the presentable representation of the first web page 110a can be in any form that optimizes efficiency with respect to transmission over the network 12. For example, the presentable representation of the first web page 110a can include an image representation of the first web page, a MIME encoded markup representation of the first web page, and/or a combination of both markup and images representing the first web page 110a. In addition to the presentable representation of the first web page 110a and the request for the second web page 110b, the content in the HTTP request headers can include a request for a transition video object stream 220 that includes a client port number through which the transition video object stream 220 is to be transmitted to the client device 400.

In one embodiment, the content handler component 211 can pass the URL for the second web page 110b and the content comprising the presentable representation of the first web page 110a to a page retriever component 212. In response to receiving the URL for the second web page 110b, the page retriever component 212 can call the content handler component 211 to retrieve the second web page 110b via the network 12. For example, the content handler component 211 can create an HTTP request header including the URL for the second web page 110b and can call the network stack component 202 to retrieve the second web page 110b over the network 12. Once retrieved, the content handler component 211 returns the second web page 110b, which can include images, style sheets, JavaScript files and other MIME encoded content, and to the page retriever component 212.

When the page retriever component 212 receives the second web page 110b, the second web page 110b is rendered to retrieve content associated with the second web page 110b including a presentable representation of the second web page (block 302). According to an exemplary embodiment, the transition service 210 includes means for rendering the second webpage 110b to retrieve content associated with the second web page 110b. For example, the page retriever component 212 can be configured for performing this function.

In one embodiment, the page retriever component 212 can invoke a page rendering processor component 213 to render the presentable representation of the second web page. For example, the page rendering processor component 213 can interpret the markup and other associated MIME encode content of the second web page 110b and render the content into the presentable representation of the second web page. In one embodiment, the presentable representation of the second web page 110b can be an image representation of the entire web page, or some combination of markup, images and other components.

While the second web page 110b is being rendered, the transition video object stream 220 is generated and includes a first frame including content related to the content associated with the first web page 110a, an intermediate frame that does not include the content associated with the first 110a and second 110b web pages, and a final frame including content related to the content associated with the second web page 110b (block 304). As the transition video object stream 220 is being generated, it is sent to the client browser 410 for presentation in conjunction with the first 110a and second 110b web pages (block 306). According to one embodiment, the transition service 210 includes means for generating the transition video object stream 220 and means for sending the transition video object stream 220 to the client browser 410. For example, the transition service 210 can include a transition video rendering (TVR) processor component 214 for generating the transition video object stream 220 and a video streamer component 218 for sending the transition video object stream 220 to the browser 410.

In an exemplary embodiment, when the page retriever component 212 calls the content handler component 211 to retrieve the second web page 110b, it also calls and passes the presentable representation of the first web page 110a, and the request for the transition video object stream 220 to the TVR processor component 214. With this information, the TVR processor component 214 can, in one embodiment, create a first video segment that includes the first frame that has content related to the content associated with the first web page 110a, e.g., the presentable representation of the first web page. For example, the first video segment of the transition video object 220 can include a plurality of video frames that show the presentable representation of the first web page 110a changing its size and shape, moving across a presentation space, and/or eventually disappearing from the presentation space.

The first video segment can segue into a second video segment that includes the intermediate frame that does not have content from either the first web page 110a or the second web page 110b. That is, the second video segment's content is completely independent from the content associated with the first 110a and second 110b web pages. In one embodiment, a plurality of transition segments 215 can be stored in a data store 216. The transition segments 215 can be associated with a transition preference of web sites hosting web pages 110a, 110b or by users. For example, a website that hosts web pages relating to Hawai'i can prefer transition segments that include videos describing points of interest in Maui or Kona.

In one embodiment, the TVR processor component 214 can select a transition segment 215 based on a transition preference of a first website hosting the first web page 110a and/or a second website hosting the second web page 110b. The transition segment 215 can also be selected based on the content associated with the first web page 110a and/or the content associated with the second web page 110b.

Once selected, the TVR processor component 214 generates the second video segment using the selected transition segment 215. In an exemplary embodiment, the first video segment can incorporate a portion of the content of the selected transition segment such that a smooth transition from the first video segment to the second video segment is created. The duration of the first and second video segments can vary depending on the time required for receiving and rendering the second web page 110b.

When the presentable representation of the second web page is rendered and available, the TVR processor component 214 can, in one embodiment, create a third video segment that includes the final frame that has the content related to the content associated with the second web page 110b, e.g., the presentable representation of the first second page. For example, the third video segment of the transition video object 220 can include a plurality of video frames that show the presentable representation of the second web page materializing from the content of the transition segment 215, moving across the presentation space, and/or coming into focus from a corner of the presentation space. As with the first video segment, the third video segment can incorporate a portion of the content of the selected transition segment such that a smooth transition from the second video segment to the third video segment is created.

According to an exemplary embodiment, as the TVR processor component 214 is generating the transition video object stream 220, the video streamer component 218 can be invoked to begin streaming frames of the transition video object stream 220 to the client browser 410 as they are created and/or rendered. In one embodiment, the video streamer component 218 can call the network stack component 202 to transfer the frames of the transition video object stream 220 using the client port number associated with the request. Any suitable video streaming protocol may be used to transfer the video stream 220 to the client 400. For example, protocols specifically designed to stream media over networks can include datagram protocols, e.g., User Datagram Protocol (UDP), Real-time Streaming Protocols (RTSP), Real-time Transport Protocols (RTP), and the Real-time Transport Control Protocols (RTCP). Other choices include the Transmission Control Protocol (TCP), Unicast, Multicast, IP Multicast, and peer to peer protocols.

While the TVR processor component 214 and the video streamer component 218 generate and stream, respectively, the transition video object stream 220, the page retriever component 212 continues to receive and render the contents of the second web page 110b in one embodiment. When the second web page 110b is completely rendered, the page retriever component 212 can return the content of the second web page 110b to the client 400 by calling the content handler component 211, which sends the content of the second web page 110b to the client 400 via the network stack component 202 to satisfy the original HTTP request for the second web page 110b. Accordingly, when the transmission of the transition video object stream 220 is completed, the content of the second web page 110b can be presented in the client browser 410.

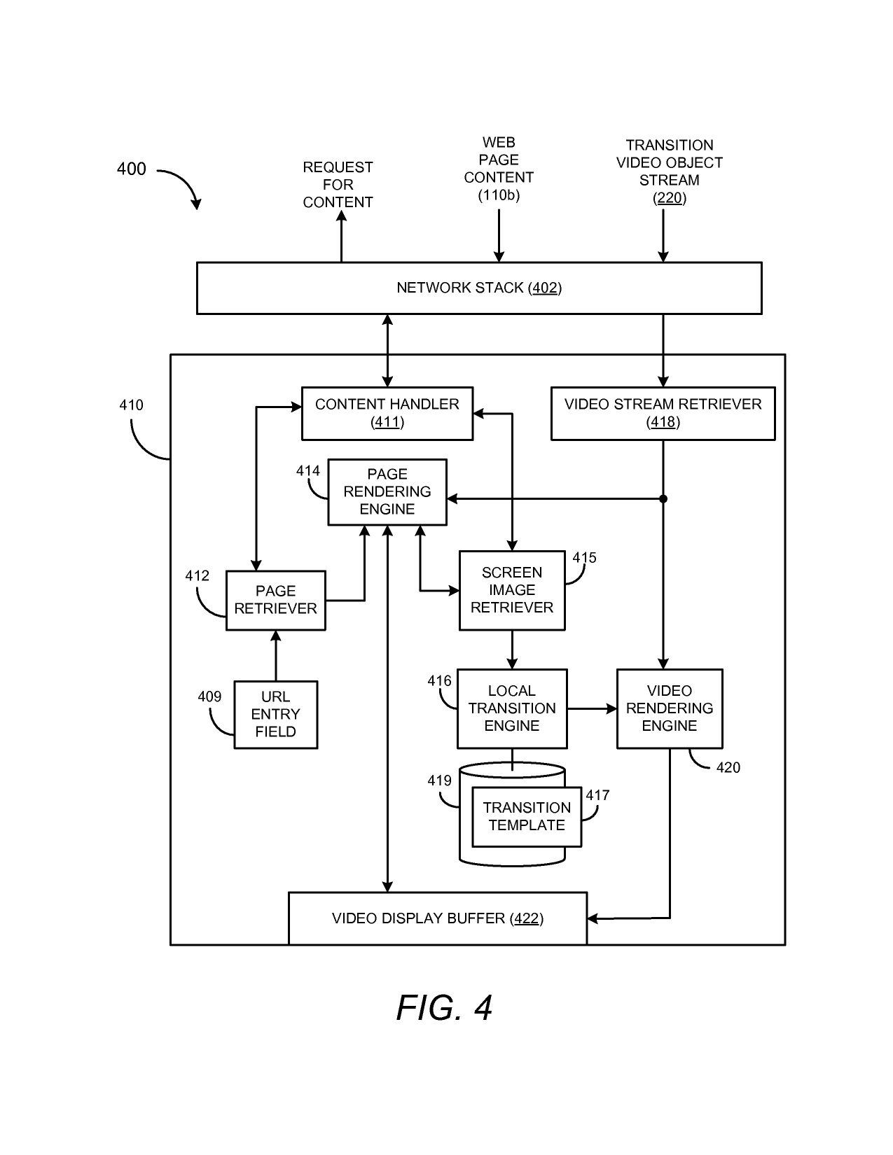

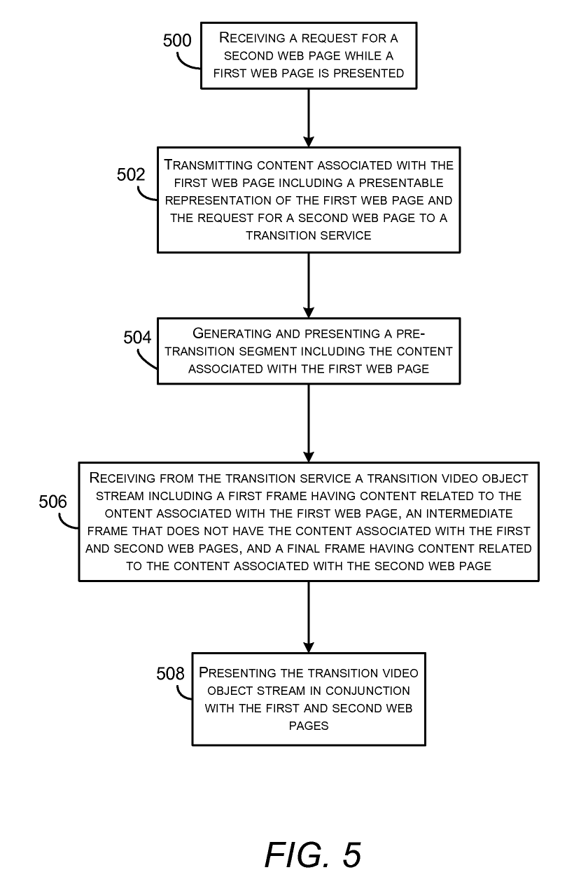

To describe more fully the functionality of the client browser 410, reference to FIG. 4 and FIG. 5 is made. FIG. 4 is a block diagram illustrating a client device 400 according to one embodiment, and FIG. 5 is a flowchart illustrating an exemplary method for presenting transitional information while a web page is being rendered from a perspective of the client browser 410 according to one embodiment. According to the exemplary method, the process begins when a request for the second web page 110b is received while the first web page 110a is presented in the client browser 410 (block 500). In one embodiment, the client browser 410 includes means for receiving the request for the second web page 110b while the first web page 110a is presented. For example, the client browser 410 can include a page retriever component configured to perform this function.

According to an exemplary embodiment, a user interface component (not shown) includes a URL entry field 409 in which the URL of the second web page 110b can be entered and requested. Alternatively, or in addition, the URL of the second web page 110b can be selected from a list of bookmarks (not shown), or by activating a hyperlink within the presented first web page 110a. In one embodiment, when the URL of the second web page 110b is entered, e.g., via the URL entry field 409, the URL and the request is sent to the page retriever component 412 for further processing.

Once the request for the second web page 110b is received, content associated with the first web page 110a that includes a presentable representation of the first web page 110a, and the request for the second webpage are transmitted to a transition service 210 (block 502). According to an exemplary embodiment, the client browser 410 includes means for transmitting the content associated with the first web page 110a and the request for the second webpage 110b to the transition service 210. For example, the client browser 410 can include a content handler component 411 configured for performing this function.

In one embodiment, the content handler component 411 is configured to send and receive HTTP messages to and from the transition device 400 via the network 12. Thus, when the page retriever component 412 receives the request for the second web page 110b, it can call the content handler component 411, in one embodiment, to format an HTTP request whose content includes the request for the second web page. In addition, when the content handler component 411 formats the HTTP request, it retrieves the presentable representation of the first web page 110a so that it can also be included in the content of the HTTP request.

For example, in one embodiment, the content handler component 411 can call a screen image retriever component 415 to retrieve the presentable representation of the first web page 110a. The screen image retriever component 415 can be configured to call a page rendering engine component 414 to retrieve the content of the first web page 110a from the browser's video display buffer component 422 and to format the content into the presentable representation of the first web page 110a. As described above, the presentable representation of the first web page 110a can include an image representation of the first web page 110a and/or a MIME encoded markup representation of the first web page 110a.

The content handler component 411 receives the presentable representation for the first web page 110a and includes this content along with the request for the second web page 110b in the content of the HTTP request. In one embodiment, the request for the second web page 110b can also include an identifier of the second web page 110b, e.g., a representation of the second web page's URL, a request to generate the transition video object stream 220, and/or a specified communication port through which information can be received.

The content handler component 411 sends the request for the second web page 110b and the content associated with the first web page 110a to the transition service 410 over the network 12 via a network stack component 402. While the network stack component 402 begins listening on the specified communications port for the video transition object stream 220, a pre-transition video segment including the content associated with the first web page 110a is generated and presented (block 504). In an exemplary embodiment, the client browser 410 includes means for generating and presenting the pre-transition segment including the content associated with the first web page. For example, a local transition engine component 416 in the client browser 410 can be configured to perform this function.

In one embodiment, the pre-transition video segment is presented while the client browser 410 is waiting to receive the first frames of the transition video object stream 220. When generating the pre-transition video segment, in one embodiment, the local transition engine component 416 can be configured to retrieve a transition template 417 that includes an executable program and/or a set of instructions from a data store 419 coupled to the local transition engine 416. The local transition engine component 416 receives the presentable representation of the first web page 110a from the screen image retriever component 415 and incorporates the content associated with the first web page 110a with the transition template 417 to produce a stream of video frames including the presentable representation of the first web page 110a.

In one embodiment, the pre-transition video segment can show the presentable representation of the first web page 110a changing its size and shape, moving across a presentation space, and/or shrinking and disappearing from the presentation space. As each video frame is produced, the local transition engine 416 can be configured to call a video rendering engine component 420 to render the frame to the video display buffer component 422 so that it can be presented on the display (not shown).

As the pre-transition video segment is presented, the transition video object stream 220 including a first frame including content related to the content associated with the first web page 110a, an intermediate frame that does not include the content associated with the first 110a and second 110b web pages, and a final frame including content related to the content associated with the second web page 110b is received from the transition service (block 506). As the frames of the transition video object stream 220 are received, the transition video object stream is presented in conjunction with the first 110a and second 110b web pages (block 508). In an exemplary embodiment, the client browser 410 includes means for receiving the transition video object stream 220 and means for presenting the transition video object stream 220 in conjunction with the first 110a and second 110b web pages. For example, the client browser 410 can include a video stream retriever component 418 configured for receiving the transition video object stream 220, and a video rendering engine 420 configured for presenting the transition video object stream 220.

According to one embodiment, the video stream retriever component 418 is configured for receiving video frames of the transition video object stream 220 from the network stack component 402 via the communications port specified in the request for the video transition object stream 220. The video stream retriever component 418 sends the frames for rendering by calling the video rendering engine 420 to render each frame into the video display buffer component 422 so that the transition video object stream 220 can be presented following the presentation of the pre-transition video segment.

As described above, the transition video object stream 220 includes a first video segment that includes the content associated with the first web page 110a, a second video segment that does not have content from either the first web page 110a or the second web page 110b, and a third video segment that has the content associated with the second web page 110b. In an exemplary embodiment, the beginning of the first video segment of the transition video object stream 220 incorporates a portion of the end of the pre-transition video segment to provide a smooth transition from the pre-transition video segment to the transition video object stream 220. For example, the beginning of the first video segment and the end of the pre-transition video segment can show the presentable representation of the first web page 110a in the same corner of the presentation space so that the transition from the pre-transition video segment to the first video segment is seamless.

According to an exemplary embodiment, while the video stream retriever component 418 is receiving the transition video object stream 220 and the video rendering engine 420 is presenting the transition video object stream 220, the content handler component 411 is receiving the contents of the second web page 110b in response to the request. As the content is received, the content handler component 411 is configured to return the content to the page retriever component 412, which invokes the page rendering engine 414 to render the second web page 110b. In an exemplary embodiment, when the second web page 110b is completely rendered, the page rendering engine 414 is configured to cache the second web page 110b while the transition video object stream is being presented.

According to one embodiment, when the entire transition video object stream 220 has been rendered, the video stream retriever component 418 notifies the page rendering engine 414 to render the second web page 110b. In response, the page rendering engine 414 can send the content of the second web page 110b to the video display buffer component 422 for presentation in the display.

According to aspects of the embodiments described, a visual experience that transitions between a first web page and a second web page is realized using a video transition object stream that provides a continuous and smooth transition between the content of the first web page 110a and the content of the second web page 110b. For example, a user can be surfing a Paris Tourist center web site for information on the Eiffel Tower and decide to invoke a link on the tourist center web site that is linked to the Eiffel Tower web site. The transition service 410 can generate a transition video object stream 220 based on preferences of the web sites or other metadata that provides a helicopter flight from the tourist center at the Paris Airport to the Eiffel tower. The transition video object stream 220 can begins with a view of the tourist site web page, e.g., 110a, which is faded to the bottom right of the presentation space of the browser 410, as the camera view of a walk to a helicopter begins rendering. The helicopter takes off in flight and the video shows views of Paris as the helicopter approaches the Eiffel Tower. As the helicopter lands at the Eiffel Tower, the camera pans toward the ticket booth and zooms in. As part of the zoom sequence the second web page 110b representing the Eiffel Tower web site is zoomed in full screen.

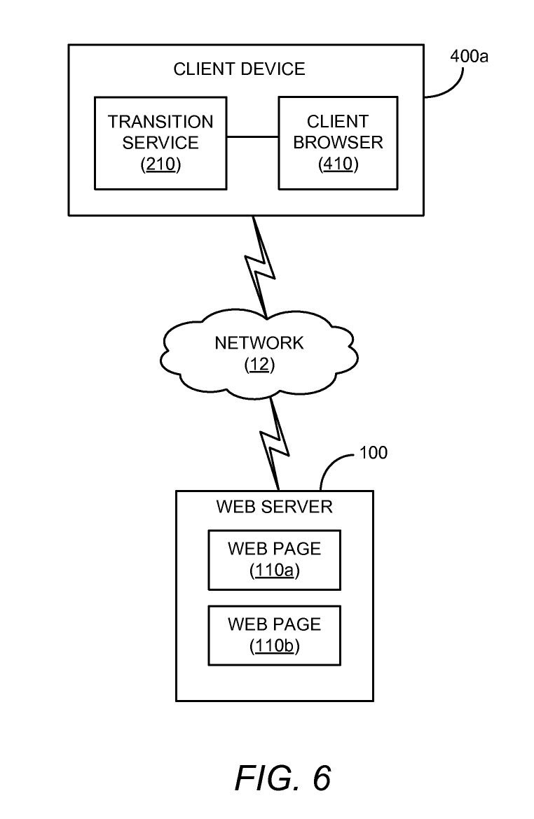

According to the embodiments described, the task of rendering the transition video object stream 220 can be off-loaded to the transition service 210 in a secondary processing unit in a remote device 200 so that the client device 400 can be a thin device, e.g., a handheld mobile device. In another embodiment, shown in FIG. 6, the transition service 210 can be integrated with the client device 400a. In this embodiment, the transition service 210 is supported by a secondary processing unit in the client device 400a that is independent from a primary processing unit supporting the client browser 410.

Through aspects of the embodiments described, a continuous and smooth transition between the content of the first web page 110a and the content of the second web page 110b is provided. It should be understood that the various components illustrated in the various block diagrams represent logical components that are configured to perform the functionality described herein and may be implemented in software, hardware, or a combination of the two. Moreover, some or all of these logical components may be combined, some may be omitted altogether, and additional components can be added while still achieving the functionality described herein. Thus, the subject matter described herein can be embodied in many different variations, and all such variations are contemplated to be within the scope of what is claimed.

To facilitate an understanding of the subject matter described above, many aspects are described in terms of sequences of actions that can be performed by elements of a computer system. For example, it will be recognized that the various actions can be performed by specialized circuits or circuitry (e.g., discrete logic gates interconnected to perform a specialized function), by program instructions being executed by one or more processors, or by a combination of both.

Moreover, executable instructions of a computer program for carrying out the methods described herein can be embodied in any machine or computer readable medium for use by or in connection with an instruction execution machine, system, apparatus, or device, such as a computer-based or processor-containing machine, system, apparatus, or device, that can read or fetch the instructions from the machine or computer readable medium and execute the instructions.

As used here, a “computer readable medium” can be any means that can contain, store, communicate, propagate, or transport the computer program for use by or in connection with the instruction execution machine, system, apparatus, or device. The computer readable medium can be, for example, but not limited to, an electronic, magnetic, optical, electromagnetic, infrared, or semiconductor machine, system, apparatus, device, or propagation medium. More specific examples (a non-exhaustive list) of the computer readable medium can include the following: a wired network connection and associated transmission medium, such as an ETHERNET transmission system, a wireless network connection and associated transmission medium, such as an IEEE 802.11(a), (b), (g), or (n) or a BLUETOOTH transmission system, a wide-area network (WAN), a local-area network (LAN), the Internet, an intranet, a portable computer diskette, a random access memory (RAM), a read only memory (ROM), an erasable programmable read only memory (EPROM or Flash memory), an optical fiber, a portable compact disc (CD), a portable digital video disc (DVD), and the like.

Thus, the subject matter described herein can be embodied in many different forms, and all such forms are contemplated to be within the scope of what is claimed. It will be understood that various details of the invention may be changed without departing from the scope of the claimed subject matter. Furthermore, the foregoing description is for the purpose of illustration only, and not for the purpose of limitation, as the scope of protection sought is defined by the claims as set forth hereinafter together with any equivalents thereof entitled to.

What is claimed is:

1. A method for presenting a transition between content in web pages, the method comprising:
receiving content associated with a first web page and a request for a second web page, wherein the content associated with the first web page includes a presentable representation of the first web page;
rendering the second webpage to retrieve content associated with the second web page including a presentable representation of the second web page;
generating a transition video object stream including a first frame including content related to the content associated with the first web page, an intermediate frame that does not include the content associated with the first and second web pages, and a final frame including content related to the content associated with the second web page; and
sending the transition video object stream to a browser for presentation in conjunction with the first and second web pages.

2. The method of claim 1 wherein the request includes at least one of an identifier of the second web page, a request to receive the transition video object stream, and a communication port number to which information is to be sent.

3. The method of claim 1 wherein the presentable representation of the first web page includes at least one of an image representation of the first web page and a MIME encoded markup representation of the first web page.

4. The method of claim 1 wherein generating the transition video object stream includes:
creating a first video segment including the first frame and the presentable representation of the first web page;
creating a second video segment including the intermediate frame; and
creating a third video segment including the final frame and a presentable representation of the second web page.

5. The method of claim 4 further comprising:
storing a plurality of transition segments in a data store, wherein the plurality of transition segments is associated with a transition preference of at least one of a first web site hosting the first web page and a second web site hosting the second web page.

6. The method of claim 5 wherein creating the second video segment includes:
selecting a transition segment from the data store based on at least one of the transition preference, the content associated with the first web page and the content associated with the second web page;
continuously generating the second video segment using the transition segment; and
streaming the second video segment to the browser until the second web page is completely rendered.

7. The method of claim 6 wherein creating the first video segment includes incorporating the content associated with the first web page with a portion of content of the transition segment resulting in a smooth transition from the first video segment to the second video segment.

8. The method of claim 6 wherein creating the third video segment includes incorporating the content of the transition segment with a portion of the content associated with the second web page resulting in a smooth transition from the second video segment to the third video segment.

9. The method of claim 1 further comprising sending the rendered second web page to the browser for presentation independently from the transmission of the transition video object stream.

10. A system for presenting a transition between content in web pages, the system including:
a content handler component configured for receiving content associated with a first web page and a request for a second web page, wherein the content associated with the first web page includes a presentable representation of the first web page;
a page retriever component configured for rendering the second webpage to retrieve content associated with the second web page including a presentable representation of the second web page;
a transition video rendering processor configured for generating a transition video object stream including a first frame including content related to the content associated with the first web page, an intermediate frame that does not include the content associated with the first and second web pages, and a final frame including content related to the content associated with the second web page; and
a video streamer component configured for sending the transition video object stream to a browser for presentation.

11. The system of claim 10 wherein the request includes at least one of an identifier of the second web page, a request to receive the transition video object stream, and a communication port number to which information is to be sent.

12. The system of claim 10 wherein the presentable representation of the first web page includes at least one of an image representation of the first web page and a MIME encoded markup representation of the first web page.

13. The system of claim 10 wherein the transition video rendering processor is configured for creating a first video segment including the first frame and the presentable representation of the first web page, creating a second video segment including the intermediate frame, and creating a third video segment including the final frame and a presentable representation of the second web page.

14. The system of claim 13 further comprising a data store configured for storing a plurality of transition segments, wherein the plurality of transition segments is associated with a transition preference of at least one of a first web site hosting the first web page and a second web site hosting the second web page.

15. The system of claim 14 wherein the transition video rendering processor is configured for creating the second video segment by selecting a transition segment from the data store based on at least one of the transition preference, the content associated with the first web page and the content associated with the second web page, and continuously generating the second video segment using the transition segment.

16. The system of claim 15 wherein the video streamer component is configured for streaming the second video segment to the browser until the second web page is completely rendered.

17. The system of claim 16 wherein the transition video rendering processor is configured for creating the first video segment by incorporating the content associated with the first web page with a portion of content of the transition segment resulting in a smooth transition from the first video segment to the second video segment, and for creating the third video segment includes incorporating the content of the transition segment with a portion of the content associated with the second web page resulting in a smooth transition from the second video segment to the third video segment.

18. The system of claim 10 wherein the video streamer component is configured for streaming the rendered second web page to the browser for presentation independently from the transmission of the transition video object stream.

19. A system for presenting a transition between content in web pages, the system including:
means for receiving content associated with a first web page and a request for a second web page, wherein the content associated with the first web page includes a presentable representation of the first web page;
means for rendering the second webpage to retrieve content associated with the second web page including a presentable representation of the second web page;
means for generating a transition video object stream including a first frame including content related to the content associated with the first web page, an intermediate frame that does not include the content associated with the first and second web pages, and a final frame including content related to the content associated with the second web page; and
means for sending the transition video object stream to a browser for presentation.

20. A computer readable medium containing a computer program, executable by a machine, for presenting a transition between content in web pages, the computer program comprising executable instructions for:
receiving content associated with a first web page and a request for a second web page, wherein the content associated with the first web page includes a presentable representation of the first web page;
rendering the second webpage to retrieve content associated with the second web page including a presentable representation of the second web page;
generating a transition video object stream including a first frame including content related to the content associated with the first web page, an intermediate frame that does not include the content associated with the first and second web pages, and a final frame including content related to the content associated with the second web page; and
sending the transition video object stream to a browser for presentation.

21. A method for presenting transitional information while a web page is being rendered, the method comprising:
receiving a request for a second web page while a first web page is presented;
transmitting content associated with the first web page and the request for the second webpage to a transition service, wherein the content associated with the first web page includes a presentable representation of the first web page;
generating and presenting a pre-transition video segment including the content associated with the first web page;
receiving from the transition service a transition video object stream including a first frame including content related to the content associated with the first web page, an intermediate frame that does not include the content associated with the first and second web pages, and a final frame including content related to the content associated with the second web page; and
presenting the transition video object stream in conjunction with the first and second web pages.
